(19) United States
(12) Patent Application Publication
(10) Pub. No.: US 2003/0012532 A1
(43) Pub. Date: Jan. 16, 2003

(54) Apparatus comprising a display unit and display unit suitable for such an apparatus

(76) Inventor: Georges Prigent, Le Mans (FR)

Correspondence Address: Philips Corporation Electronics, North America Corporation, 580 White Plains Road, Tarrytown, NY, 10591, US

(21) Appl. No.: 10/084,738

(22) Filed: Feb. 25, 2002

(30) Foreign Application Priority Data
Feb. 28, 2001 (FR) 0102765

(51) Int. Cl. G02B 6/08; F21V 8/00

(52) U.S. Cl. 385/120; 362/554

(57) ABSTRACT

This apparatus comprises a housing (1) in which a place (12) is provided for a screen formed by a display unit (15) which comprises, inter alia, an assembly of a plate of optical fibers (30) disposed on the side of the front face, facing the user (28) and a display unit (29) comprising a multiplicity of pixels.

Thanks to the plate (30) it is possible to obtain various screen configurations (by enlarging the information produced by the unit (29) or obtaining a curved screen which has very good visibility). Applications: Mobile radiotelephones, watches.

The invention relates to an apparatus comprising a housing in which a place is provided for a screen formed by a display unit which comprises, inter alia, a plate assembly of optical fibers disposed on the side of the front face, facing the user and a display unit which comprises a multiplicity of pixels.

The invention also relates to a display unit suitable for such an apparatus.

Such an apparatus is described in patent document no. GB 2 058 384 which comprises a plate assembly of optical fibers. Among other effects, this plate permits to “reshow” the image produced by the display unit on the outside surface of the housing, which permits a better display quality.

The invention proposes an apparatus of the type mentioned in the opening paragraph which permits to provide varied display configurations.

For this purpose, such an apparatus is characterized in that the fibers of the plate are deformed to be adapted to various configurations.

One of the configurations permits, for example, to obtain a convex screen. Another interesting configuration is a screen that shows enlarged characters.

These and other aspects of the invention are apparent from and will be elucidated, by way of non-limitative example, with reference to the embodiment(s) described hereinafter.

In the drawings:

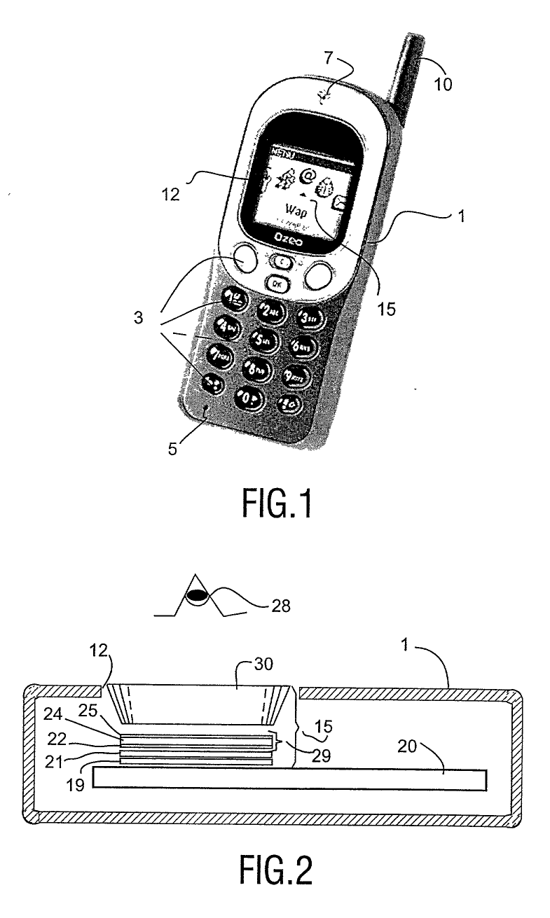

FIG. 1 shows a diagram of the apparatus according to the invention,

FIG. 2 shows in more detail the structure of an apparatus according to the invention,

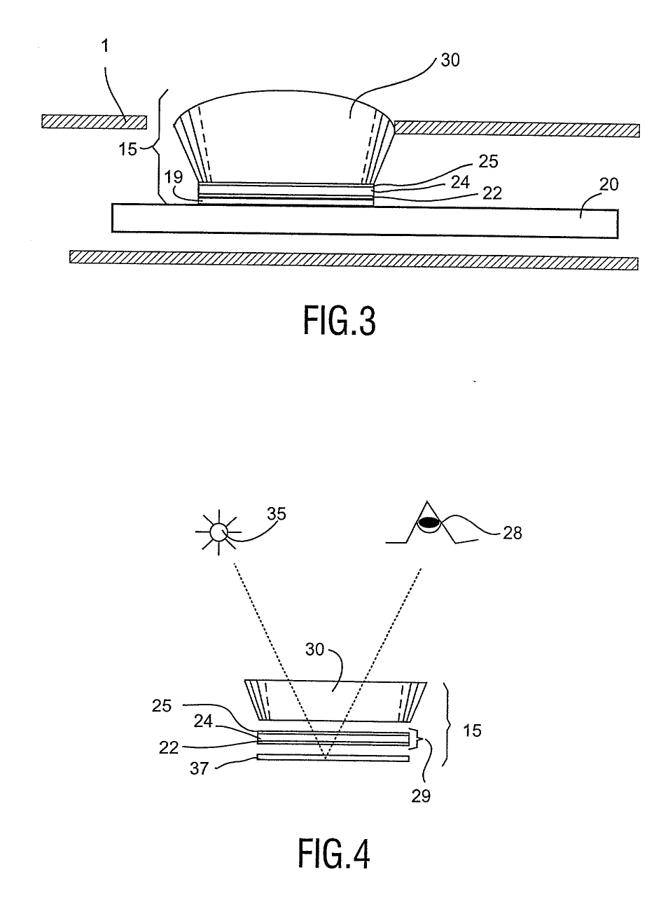

FIG. 3 shows a variant of embodiment of an apparatus according to the invention,

FIG. 4 shows a display unit functioning by reflection according to the invention.

In FIG. 1 is shown an apparatus according to the invention. Within the scope of the described example this is a mobile radiotelephone. It is in the form of a housing 1 on which are disposed, inter alia, a keypad 3, a microphone 5 and a loudspeaker 7. Furthermore, it is used for fastening an antenna 10. In the housing 1 is provided an opening 12 for a display unit 15.

FIG. 2 shows a diagrammatic view, partially exploded, of a cross-section of the apparatus according to the invention. The display unit 15 is in the form of a light box 19 installed on the printed circuit board 20 which comprises largely all the elements of the apparatus. This light box may be realized by means of LED diodes or by means of a crosswise illuminated light guide. On top of this light box there is a reflective or semi-reflective film 21. On this film there is the layer 22 in which the conductors are superimposed which control the display and the first polarizer. On top of this layer is a liquid crystal layer 24 on which is disposed another layer 25 of conductors and film polarizer. The observer 28 thus sees the data displayed by a transmission path. The polarizers are to be cross-polarized. The polarizers and the layer 24 form the display unit 29 where thus the images formed by active or passive pixels are formed intended to be perceived by the user.

According to the invention, a plate 30 of optical fibers of which the fibers are deformed is placed on the layer 24. Thus in FIG. 2 the plate of optical fibers behaves as an image magnifier. This may be obtained by imposing different pressures at the ends of this plate during manufacture. The diameter of the fibers at the end, which contact the display unit, is smaller than that of the ends at the front face. To avoid the problems of precision, the diameter of the fibers which are in contact with the layer 25 is to be smaller than the dimensions of the pixels which the display unit is capable of displaying.

FIG. 3 shows another example of embodiment of an apparatus according to the invention. The common elements with those of the preceding Figures carry like references. In this example the screen has a convex bent surface which provides a better ease of reading to the user. This bent surface can be obtained by a machining of the plate 30.

FIG. 4, in which the common elements with those of the preceding Figures also carry like references, shows another example of embodiment of the invention. Here the fact is illustrated that this unit can also be used in reflection.

For this purpose, a light source 35 is arranged on the side of the observer 28. The light produced by this source is reflected by a reflector 37 situated just underneath the layer 24. The light thus passes through the display unit 29 twice.

This invention profits from the fact that the polarizers may have very thin thicknesses and that they can be next to the control conductors (known as ITO). These polarizers may be provided by OPTIVA Inc.:

“Optiva Inc.”

Tel. 650-616-7600

Fax 650-616-7602

377 Oister Point Boulevard, Unit 13

South San Francisco, Calif. 94080, USA”.

Although the invention has been described for an apparatus of the portable radiotelephone type, the invention may also find other applications, for example, watches and calculators.

1. An apparatus comprising a housing in which a place is provided for a screen formed by a display unit which comprises, inter alia, a plate assembly of optical fibers disposed on the side of the front face, facing the user and a display unit which comprises a multiplicity of pixels, characterized in that the fibers of the plate are deformed so as to be adapted to various configurations.

2. An apparatus as claimed in claim 1, characterized in that the front face of the plate is bent.

3. An apparatus as claimed in claim 2, characterized in that the fibers have a changing diameter.

4. An apparatus as claimed in one of the claims 1 to 3, characterized in that the display unit comprises a light box situated underneath.

5. An apparatus as claimed in one of the claims 1 to 3, characterized in that the display unit comprises a reflector situated underneath for reflecting the light from a light source situated above it.

6. An apparatus as claimed in one of the claims 1 to 5, for which the display unit is of the liquid crystal display type implying two crossed polarizers, characterized in that one of the polarizers is placed at the back of the plate of optical fibers.

7. An apparatus as claimed in one of the claims 1 to 5, characterized in that the diameter of the fibers which are in contact with the display unit is smaller than the dimensions of the pixels which the display unit can display.

8. A display unit suitable for an apparatus as claimed in one of the claims 1 to 7, comprising inter alia an assembly of a fiber optic plate placed on the side of the front face facing the user and a display unit comprising a multiplicity of pixels, characterized in that the fibers of the plate are deformed so as to be adapted to various configurations.

9. A display unit as claimed in claim 8, comprising a liquid crystal display unit involving two crossed polarizers, characterized in that one of the polarizers is placed at the back of the optical fiber plate.

10. A display unit as claimed in one of the claims 8 to 9, characterized in that the diameter of the fibers in contact with the display unit is smaller than the dimensions of the pixels which the display unit can display.
